(19) United States
(12) Patent Application Publication
(10) Pub. No.: US 2006/0127870 A1
(43) Pub. Date: Jun. 15, 2006

(54) System and method for communicating student information among student, parents guardians and educators

(75) Inventors: Edward M. Fields, Los Gatos, CA (US); Steven B. Bowler, Hudson, MA (US)

Correspondence Address: STEVENS LAW GROUP, P.O. BOX 1667, SAN JOSE, CA, 95109, US

(73) Assignee: HotChalk, Inc., Los Gatos, CA (US)

(21) Appl. No.: 11/305,174

(22) Filed: Dec. 15, 2005

Related U.S. Application Data
(60) Provisional application No. 60/636,691, filed on Dec. 15, 2004.
(60) Provisional application No. 60/681,895, filed on May 16, 2005.

(51) Int. Cl. G09B 3/00

(52) U.S. Cl. 434/350

(57) ABSTRACT

A system and method is provided for communicating student information among students, guardians, parents, administrators and educators with interface areas for each of them, the system configured to perform the method of maintaining assignments for students; grading responses to assignments provided by students; analyzing grades for each student; and notifying one of educators, a student and at least one of the student's parents and guardians if the student's grade triggers an event. If an event is triggered, such low grades, high grades, truancy or other student issues, then conferences can be scheduled or other activities.

### RELATED APPLICATIONS

This application claims priority based on U.S. Provisional Application No. 60/636,691 filed on Dec. 15, 2004 and U.S. Provisional Application No. 60/681,895 filed on May 16, 2005.

### BACKGROUND

The role of parents in a child's education is well known. Parents are children's earliest educators and have a lasting influence on their child's perception of education. During the early school years, children look to parents for leadership in dealing with personal, peer, and academic pressures. Both parents and teachers contribute to the healthy growth and development of a child. Congressional findings indicate that parental involvement in a child's education contributes to such positive outcomes as improved grades and test scores, higher expectations for student achievement, better school attendance, improved rates of homework completion and graduation from secondary schools, decreased violence and substance abuse, and higher rates of graduation from secondary and enrollment in postsecondary schools.

Additionally, Congressional studies show that 95 percent of parents strongly agree that parental involvement is as important a factor as quality of teachers in ensuring student success in school, and 69 percent of parents believe that in order to improve public schools, more opportunities for parental involvement are necessary. Of the 800 parents questioned under the National Parent Teacher Association's 1998 survey of public school parents, more than half stated that low levels of parental involvement and the inability of schools to keep parents informed are serious problems. Teachers rank strengthening parental roles in their children's education as an important issue that should receive the highest priority in the formulation of public education policy over the next few years. A positive link must be made between the school and the home; the parents and the teachers are both vital parts of the child's life and education. This link starts with good communication among the teacher, the student, and the parents.

Prior methods of communication included the traditional report cards and quarterly parent teacher conferences. Grades were usually reported to parents quarterly, and the lag time between when the grade is recorded and when it is reported made remedial action difficult and often ineffective. Parents also have had to rely on students to report individual test and assignment grades to get any idea of interim progress. Internet access and the use of web pages have improved the reporting structure for communicating a student's assignments and grades in real time. Real time reporting of grades alone, however, does little to communicate to the parents about the development of their child as a person, or involve them in resolving issues their child must overcome to achieve success, not only in school, but also in life. In an age of two-income families and single-parent households, scheduling and keeping face-to-face parent-teacher conferences are increasingly difficult.

Accordingly, there is a need for real time, continuous communication among parents, teachers, and students. Furthermore, it is desirable that this communication be scheduled and conducted remotely so as to be convenient for all parties. Additionally, it is desirable that the continuous communication among parents, teachers, and students be linked to a real time reporting structure for assignments and grades. As will be seen, the invention handles this in an elegant manner.

### BRIEF DESCRIPTION OF DRAWINGS

FIG. 1 is a flow chart illustrating one method according to the invention.

FIG. 2 is a flow chart illustrating one method according to the invention.

FIG. 3 is a diagrammatic view of a system illustrating one method according to the invention.

### DETAILED DESCRIPTION

In addressing the problems of the prior art, the invention is directed to a method wherein a continuous, real time communication link among parents, teachers, and students can be established. This communication link may use a plurality of user interfaces which are known in the field to provide for either a private, secure one to one communication between an educator and a parent or guardian, or a secure environment for communication between a group of educators and parents or guardians. When used herein, parent or guardian may be used inter-changeably, wherein they are intended to be a legal guardian of a student whether they are the biological parents, adoptive parents, relatives, or other responsible adult that is responsible for a minor student. Furthermore, the invention provides a method wherein an online scheduling tool, which may be a calendar, is maintained. This addresses the problem of the prior art for parents or guardians and teachers to be able to schedule and conduct real time communications from remote locations. Teachers, parents or guardians, and students may all have access to the scheduling tool to identify times that they will be available for real time communication, and to check on the availability of other users. In one embodiment, the scheduling tool may detect when a user is logged into the system and send out an alert to other users that this person is available. In another embodiment, the scheduling tool may also include a hot-link button that will immediately connect one user's computer to another user's computer for a quick conference if both users are logged into the system and available. Additionally, the invention may include a database, memory or other type of electronic storage for tutors and other educational resources. The database would be available for tutors to register and update information about themselves such as skills, subjects of expertise, availability, and fees. Additionally, the invention provides a method for establishing a virtual classroom environment wherein the educational process may be extended beyond the walls of the school. In this environment, teachers and educators may create and manage their curricula.

In one embodiment, the system may include a tool for communicating student information to students and parents from educators that includes a plurality of user interface areas for at least two of students, educators, and parents or guardians. The system may include a school information system database or other storage means configured to maintain curricular materials for educators, teachers, and students in electronic form. The system may include a module or subsystem for grading responses to assignments provided by students, and a subsystem or module for analyzing grades for each student. A storage may be included for recording and maintaining student grades, and also for recording available resources for providing assistance to the student according to the analyzed grades of the student. The system may further include a module or subsystem configured to enable the arrangement of online conferences among at least one of students and one of parents and guardians with an educator. The school information database may include lesson plans, assignments, and tests. The assignments and tests may be manually input by the educator. The assignments and tests may be automatically generated by a random selection of questions residing in the assignment database. The users may be notified when an assignment is ready or modified or graded. The grades for an assignment or test may be input manually by the educator or may be generated automatically. A student's grades may be measured to a predetermined scale. The grades may also or alternatively be measured to grades of other students in the class or measured to historical results of students completing the assignment. The system may inclue an alert to notify one of educators, a student and at least one of the student's parents (or guardians) that an event has occurred that requires a conference with a teacher or administrator. The event may be a student's grade is below a predetermined threshold. The event may be a behavioral issue with the student, or it also may be a request made by a parent or guardian. The scheduling system may maintain a schedule of availability of all registered users. The scheduling system may detect when a registered user is logged into the system and available.

In operation, the method performed by the system may include maintaining assignments for students; grading responses to assignments provided by students; analyzing grades for each student; and notifying one of educators, a student and at least one of the student's parents and guardians if the student's grade triggers an event. An event may occur when a student's grade is below a predetermined threshold, and the method may include arranging online conferences among at least one of students and parents and guardians with an educator. Alternative, the method further comprising providing assistance for the student using a resources database according to the analyzed grades of the student, such as tutors or other prerequisite study resources. Alternatively, an event may occur when a student's grade is above a predetermined threshold; the method further comprising sending a message to the student congratulating the student on an accomplishment. In another embodiment, and event may occur when a student incurs a truancy problem; the method further comprising arranging online conferences among at least one of students and parents or guardians with an educator.

Upon the occurrence of an event, an alert may be sent to the students and their parents or guardians by e-mail, and may include information about the assignment and the grade received. The alert may include a button for the student and parents or guardians to click to acknowledge receipt of the alert. The alert to the parents or guardians may include a button for the parents or guardians to click to contact the educator by e-mail. Alternatively, the alert to the parents or guardians may include a button for the parents or guardians to click to check the educator's availability and contact the educator by instant messaging. Or, the alert to the parents or guardians may include a response indicia configured to allow the parents or guardians to inquire into the educator's availability and schedule an online conference with the educator. The alert may also include a button for the student and parents or parents to click that may link them to a directory of available resources for providing assistance for the student, wherein the directory of available resources may include tutors.

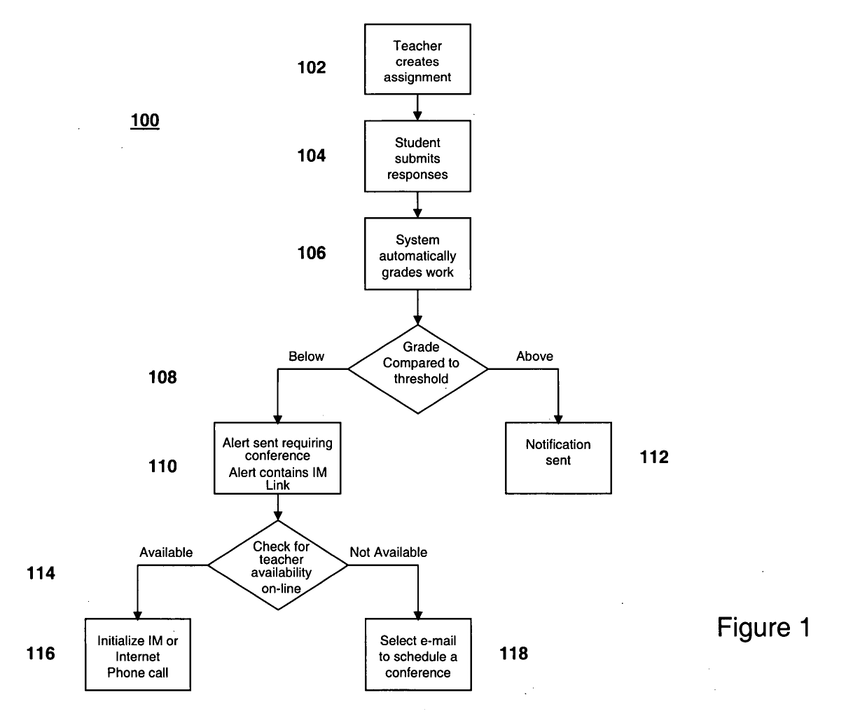

FIG. 1 shows a flow chart of one embodiment of the invention. In this embodiment 100, teachers and educators may develop lesson plans and assignments directly in the application, 102. The application may then distribute the assignments to all registered students in the class, including those who cannot physically attend school due to illness, disability, or other barriers. The students may be given a time constraint in which they are to complete the assignment online and electronically return the answers to the application for grading, 104. The teacher may grade the answers manually, or load the answer key directly into the application for automatic grading, 106. The application in this embodiment may include a database for recording and maintaining each student's grades. Each student's grades may then be compared to the grade standards of the school, 108. The school standards may be required to meet or exceed local, state and federal government educational standards.

If the student's grade is above the acceptable grade threshold, the student and the student's parents or guardians may be notified of the passing grade, 112, and may receive a type of award for accomplishment. If the grade is below the threshold, the parents or guardians may be sent an alert notification requiring or suggesting them to hold a conference with the teacher, 110. The alert message may also contain a hot-link button that activates the scheduling application to check if the teacher is available, 114. If the teacher is available, the link is made and the conference may begin immediately, 116. If the teacher is not available, the application sends a notification to the teacher to schedule a conference, 118. In one embodiment, the system may contain an automatic reply link. If a user will not be available, the user may set up an automatic reply to notify anyone trying to communicate with them that they are unavailable, and when they may be back. Additionally, the user may have the option to include alternative contact information such as a mobile or land line telephone number where the user can be reached. Conferences may also be necessary for reasons other than reviewing a student's grades. Truancy or in-school behavioural issues are examples of other issues that may necessitate a meeting. There may also be other events that trigger either an email, an alert, a suggestion for a conference or other action. One example may be a mental or physical health issue that may occur with a student. If, for example, a student appeared distressed or depressed, a teacher may want to use the system to contact the parent, possibly just to send an alert or notice, and perhaps have a conference within the system or in person. The conference may also include audio and/or video conferences that are widely available via the internet, mobile phones, land lines and other means. There are many types of events that may cause alerts in the system, and those skilled in the art or are familiar with school policies, social and medical conditions, and other issues in which parents may want to know, in which state law may require, or that may simply be appropriate to trigger an event for a particular purpose.

There may also be situations in which a parent or guardian may wish to initiate a conference with a teacher. Therefore, in one embodiment, the system is hierarchical, wherein the teacher determines when a conference will be held, and whether one is necessary. In another embodiment, the system may be more communal, where different parties may request or suggest that a conference be held.

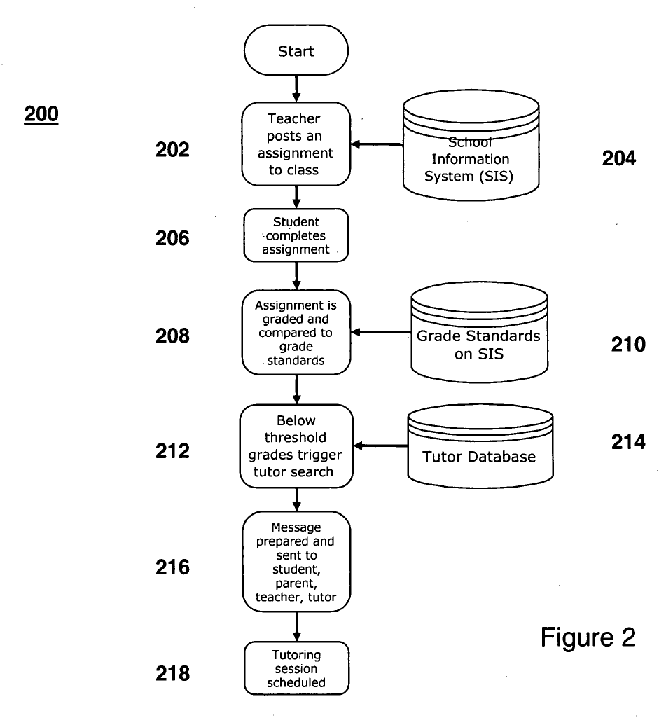

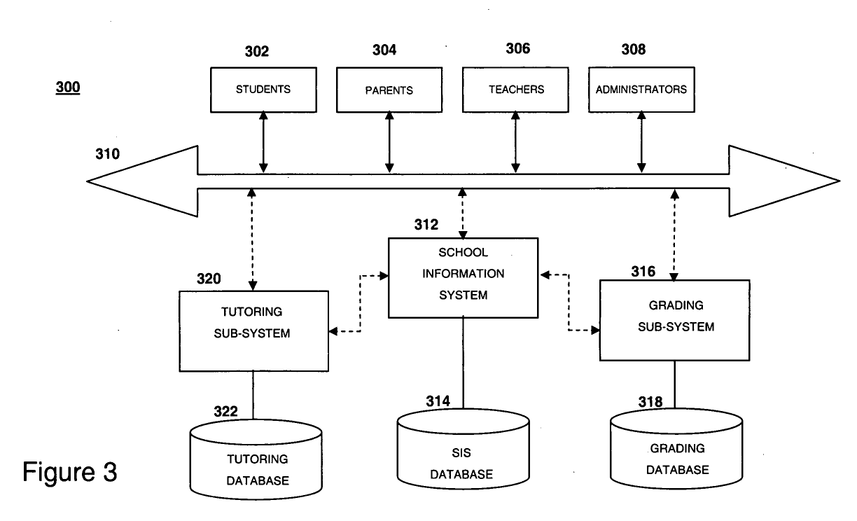

Another embodiment of the invention is illustrated in the flow chart shown in FIG. 2. In this embodiment 200, teachers and educators may develop lesson plans and assignments directly in the application, 202, or the application may include a database that contains prior lesson plans and assignments that the teachers may select for their current class, 204. Additionally, this database may contain hints and other reference materials for the students to download and use to complete their assignments and enhance their learning experience. The application may then distribute the assignments to all registered students in the class, including those who cannot physically attend school due to illness, disability, or other barriers. In another embodiment, the students may be given a time constraint in which they are to complete the assignment on line and electronically return the answers to the application for grading, 206. The assignment is graded automatically and compared to the grading standards, 208. The application in this embodiment may include a database for recording and maintaining each student's grades. This database may also house the grade standards for the school, 210. The school grade standards may be required to meet or exceed local, state and federal government grade standards. If the grade is below the threshold, 212, the application conducts a query into a database of tutors, or other educational resources, 214. The query may include criteria such as subject, grade level, deficiency, availability, fees, and geographic location. The results from the query may then be included in a notification message to the teacher, student, and parents or guardians, 216. The notification will also include links for the parents or guardians to schedule sessions with the tutor they select, 218. Referring to FIG. 3, a system embodying the invention is illustrated. The system shown is an educational communication network among the students, 302, their parents (or guardians), 304, their teachers, 306, and the school administrators, 308, and may include tutors and other interested and authorized persons. The communication link among these users, 310, may be a network, such as the internet, or a school intranet. Furthermore, the communication link may include mobile or land line phones and personal digital assistant (PDA) devices for conference calls. Also connected to the educational communication network is a school information system, 312, connected to a school information system database, 314. The school information system database, 314, may maintain files including class curricula, lesson plans, assignments, and tests. Additionally, the database may contain statistical information about the users on the network. Furthermore, another system that may be connected to the educational communication network is a grading sub-system, 316. The grading sub-system, 316, may be a program that receives completed assignments and tests electronically from the students, checks their responses, and assigns a grade to the file. Additionally, the grading sub-system, 316, may be connected to a grading database, 318. The grading database, 318, may maintain historical files on the grades received by all students. Furthermore, the grading sub-system, 316, may compare a student's grades to either the historical average or predetermined average stored in the grading database, 318, and assign a ranking to the student. The grades and rankings may then be sent through the network to the appropriate users. This ranking may also be fed into the school information system, 312, for review and further analysis. Additionally, another system that may be connected to the network is the tutoring sub-system, 320. If the school information system's analysis of a student's ranking indicates that the student is having trouble with a particular subject, a notice is sent out through the network to the appropriate users, as well as the tutoring sub-system, 320. The tutoring sub-system may then search the tutoring database, 322 to locate appropriate tutors who may help the student achieve better results in the subject in question. The tutoring database may use such criteria as areas of expertise, demographical data, and availability when selecting appropriate tutors. A list of names of potential tutors is then sent over the network to the appropriate users.

Of course, those skilled in the art will understand that the processes in these particular embodiments are not necessarily mutually exclusive, and that the invention is not limited to any particular process or set of applications, but the spirit and scope of the application extends to the scope of the appended claims and their equivalents.

1. A system for communicating student information to students and parents from educators comprising:
a plurality of user interface areas for at least two of students, educators, and parents and guardians;
a school information system database configured to maintain curricular materials for educators, teachers, and students;
a system for grading responses to assignments provided by students;
a system for analyzing grades for each student;
storage for recording and maintaining student grades;
storage for recording available resources for providing assistance to the student according to the analyzed grades of the student;
a scheduling system configured to enable the arrangement of online conferences among at least one of students and one of parents and guardians with an educator.

2. A system according to claim 1, wherein a user ID and password may be required to access information.

3. A system according to claim 1, wherein the school information database may include lesson plans, assignments, and tests.

4. A system according to claim 3, wherein the assignments and tests may be manually input by the educator.

5. A system according to claim 3, wherein the assignments and tests may be automatically generated by a random selection of questions residing in the assignment database.

6. A system according to claim 1, wherein users may be notified when an assignment is ready.

7. A system according to claim 1, wherein users may be notified when an assignment is modified.

8. A system according to claim 1, wherein users may be notified when an assignment is graded.

9. A system according to claim 1, wherein the grades for an assignment or test may be input manually by the educator.

10. A system according to claim 1, wherein the grades for an assignment or test may be generated automatically.

11. A system according to claim 1, wherein a student's grades may be measured to a predetermined scale.

12. A system according to claim 1, wherein a student's grades may be measured to grades of other students in the class.

13. A system according to claim 1, wherein a student's grades may be measured to historical results of students completing the assignment.

14. A system according to claim 1, further comprising:
an alert to notify one of educators, a student and at least one of the student's parents and guardians that an event has occurred that requires a conference with a teacher or administrator.

15. A system according to claim 14, wherein the event may be a student's grade is below a predetermined threshold.

16. A system according to claim 14, wherein the event may be a behavioral issue with the student.

17. A system according to claim 14, wherein the event may be a request made by a parent or guardian.

18. A system according to claim 1, wherein the scheduling system may maintain a schedule of availability of all registered users.

19. A system according to claim 1, wherein the scheduling system may detect when a registered user is logged into the system and available.

20. A method for communicating student information to students and parents from educators with interface areas for students, educators, and parents;
maintaining assignments for students;
grading responses to assignments provided by students;
analyzing grades for each student; and
notifying one of educators, a student and at least one of the student's parents and guardians if the student's grade triggers an event.

21. A method according to claim 20, wherein an event occurs when a student's grade is below a predetermined threshold; the method further comprising arranging online conferences among at least one of students and parents and guardians with an educator.

22. A method according to claim 20, wherein an event occurs when a student's grade is below a predetermined threshold; the method further comprising providing assistance for the student using a resources database according to the analyzed grades of the student.

23. A method according to claim 20, wherein an event occurs when a student's grade is above a predetermined threshold; the method further comprising sending a message to the student congratulating the student on an accomplishment.

24. A method according to claim 20, wherein an event occurs when a student incurs a truancy problem; the method further comprising arranging online conferences among at least one of students and parents and guardians with an educator.

25. A method according to claim 20, wherein the alert may be sent to the students and their parents or guardians by e-mail.

26. A method according to claim 20, wherein the alert may include information about the assignment and the grade received.

27. A method according to claim 20, wherein the alert may include a button for the student and parents or guardians to click to acknowledge receipt of the alert.

28. A method according to claim 20, wherein the alert to the parents or guardians may include a button for the parents or guardians to click to contact the educator by e-mail.

29. A method according to claim 20, wherein the alert to the parents or guardians may include a button for the parents or guardians to click to check the educator's availability and contact the educator by instant messaging.

30. A method according to claim 20, wherein the alert to the parents or guardians may include a response indicia configured to allow the parents or guardians to inquire into the educator's availability and schedule an online conference with the educator.

31. A method according to claim 20, wherein the alert may include a button for the student and parents or parents to click that may link them to a directory of available resources for providing assistance for the student.

32. A method according to claim 31, wherein the directory of available resources may include tutors.
